(19) United States
(12) Patent Application Publication
(10) Pub. No.: US 2026/0237797 A1
(43) Pub. Date: Aug. 13, 2026

(54) ENERGY STORAGE MODULE AND METHOD FOR MANUFACTURING ENERGY STORAGE MODULE

(71) Applicant: TOYOTA JIDOSHA KABUSHIKI KAISHA, Toyota-shi (JP)

(72) Inventor: Satoshi NAKASHIMA, Toyota-shi (JP)

(73) Assignee: TOYOTA JIDOSHA KABUSHIKI KAISHA, Toyota-shi (JP)

(21) Appl. No.: 19/424,707

(22) Filed: Dec. 18, 2025

(30) Foreign Application Priority Data
Feb. 13, 2025 (JP) 2025-021564

(51) Int. Cl. H01M 50/105; H01M 10/0525; H01M 10/058

(52) U.S. Cl. CPC H01M 50/105; H01M 10/0525; H01M 10/058

(57) ABSTRACT

An energy storage module includes a power generating element, and an outer casing that covers the power generating element. The outer casing includes a first outer casing portion that covers a surface of the power generating element, and a second outer casing portion that covers a corner of the power generating element. The first outer casing portion and the second outer casing portion are welded together so as to overlap at a position where the corner of the power generating element is located.

### CROSS-REFERENCE TO RELATED APPLICATION

This application claims priority to Japanese Patent Application No. 2025-021564 filed on February 13, 2025. The disclosure of the above-identified application, including the specification, drawings, and claims, is incorporated by reference herein in its entirety.

### BACKGROUND

### 1. Technical Field

The present disclosure relates to energy storage modules and methods for manufacturing an energy storage module.

### 2. Description of Related Art

Japanese Unexamined Patent Application Publication No. 2004-39271 (JP 2004-39271 A) discloses an energy storage module in which spacers are disposed at the inner corners of a recess of an outer casing covering a power generating element, in order to suppress damage to the outer casing.

### SUMMARY

However, when spacers are disposed inside the outer casing as in the energy storage module disclosed in JP 2004-39271 A, the volumetric energy density decreases.

The present disclosure has been made in view of the foregoing, and an object thereof is to provide an energy storage module and a method for manufacturing an energy storage module that can improve the strength of the outer casing without managing gaps using spacers.

An energy storage module according to the present disclosure includes a power generating element, and an outer casing that covers the power generating element. The outer casing includes a first outer casing portion that covers a surface of the power generating element, and a second outer casing portion that covers a corner of the power generating element. The first outer casing portion and the second outer casing portion are welded together so as to overlap at a position where the corner of the power generating element is located.

A method for manufacturing an energy storage module according to the present disclosure includes: welding a first outer casing portion configured to cover a surface of a power generating element and a second outer casing portion configured to cover a corner of the power generating element such that the first outer casing portion and the second outer casing portion overlap at a position where the corner of the power-generating element is located.

In the present disclosure, the outer casing is formed to have a multilayer structure at a position corresponding to a corner of the power generating element and is welded. As a result, the strength of the outer casing can be improved without managing gaps using spacers.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of an energy storage module according to an embodiment;

FIG. 2 is a plan view of the energy storage module according to the embodiment;

FIG. 3 illustrates a first step of a method for manufacturing an energy storage module according to the embodiment;

FIG. 4 illustrates a second step of the method for manufacturing an energy storage module according to the embodiment;

FIG. 5 illustrates a third step of the method for manufacturing an energy storage module according to the embodiment;

FIG. 6 illustrates a fourth step of the method for manufacturing an energy storage module according to the embodiment;

FIG. 7 illustrates a fifth step of the method for manufacturing an energy storage module according to the embodiment; and

FIG. 8 illustrates a modification of the first step of the method for manufacturing an energy storage module according to the embodiment.

### DETAILED DESCRIPTION OF EMBODIMENTS

An energy storage module and a method for manufacturing an energy storage module according to an embodiment of the present disclosure will be described with reference to the drawings. The components in the embodiment described below include components that can be readily replaced by those skilled in the art, or components that are substantially equivalent to those described in the embodiment.

### Energy Storage Module

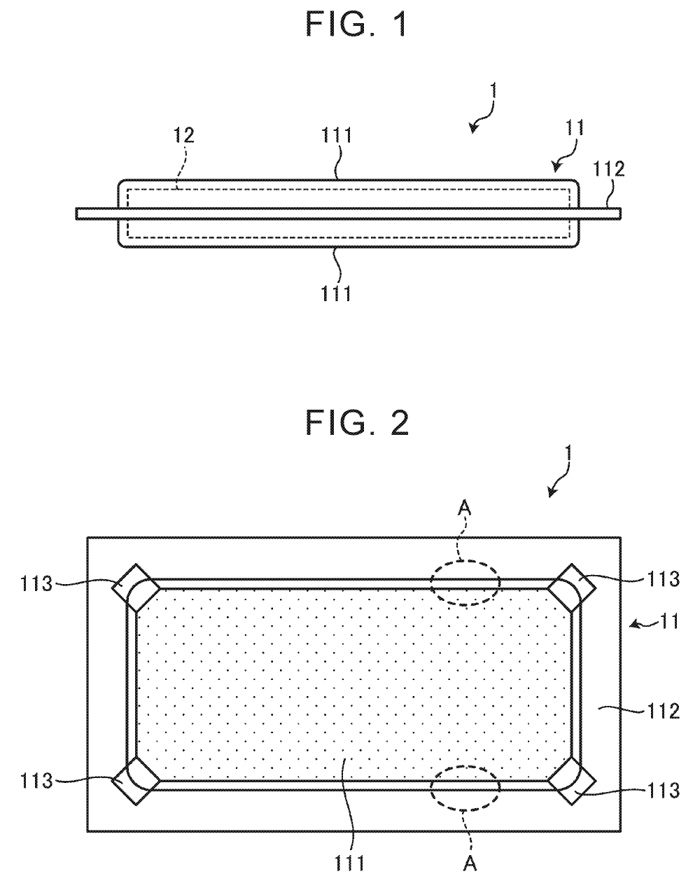

The configuration of the energy storage module according to the embodiment will be described with reference to FIGS. 1 and 2. The energy storage module of the embodiment is used as a battery for, for example, a hybrid electric vehicle, a plug-in hybrid electric vehicle, or a battery electric vehicle. The energy storage module of the embodiment is specifically a bipolar lithium-ion secondary battery.

FIG. 1 is a side view of an energy storage module 1 according to the embodiment. FIG. 2 is a plan view of the energy storage module 1. The energy storage module 1 includes an outer casing 11 and a power generating element 12.

The outer casing 11 serves to cover the power generating element 12. The outer casing 11 houses the power generating element 12 together with, for example, an electrolyte solution. As shown in FIG. 2, the outer casing 11 is formed by a first outer casing portion 111, a second outer casing portion 112, and a folded portion 113.

The first outer casing portion 111 is a current collector foil that conducts current from the power generating element 12. The outer casing 11 is an electrically conductive member in the form of a sheet, and is formed of a metal foil such as aluminum, stainless steel, iron, copper, titanium, or nickel.

As shown in FIG. 1, the first outer casing portion 111 covers the surfaces (top and bottom surfaces) of the power generating element 12. That is, the first outer casing portion 111 is provided on both the upper and lower sides of the energy storage module 1. As shown in FIG. 2, the first outer casing portion 111 generally has a rectangular shape. The first outer casing portion 111 is welded to the second outer casing portion 112 at a position of the outer edge portion of the first outer casing portion 111. The position of the outer edge portion of the first outer casing portion 111 corresponds to a position where a corner of the power generating element 12 is located.

The second outer casing portion 112 is formed of a laminate film. The laminate film constituting the second outer casing portion 112 has a structure in which multiple materials are laminated. For example, the laminate film includes a first resin layer made of nylon resin (polyamide resin), an adhesive layer, a metal layer made of aluminum foil, and a second resin layer made of polyethylene (PE) or polypropylene (PP). The first resin layer and the second resin layer are formed of such a thermoplastic resin (heat-sealable resin) as described above.

As shown in parts A of FIG. 2, the second outer casing portion 112 covers the corners (the entire peripheries of the corners) of the power generating element 12. Like the first outer casing portion 111, the second outer casing portion 112 is provided on both the upper and lower sides of the energy storage module 1. As shown in FIG. 2, the second outer casing portion 112 generally has a frame (rectangular frame) shape. The second outer casing portion 112 is welded to the first outer casing portion 111 at a position of the inner edge portion of the second outer casing portion 112. The position of the inner edge portion of the second outer casing portion 112 corresponds to a position where a corner of the power generating element 12 is located. The pair of second outer casing portions 112 arranged above and below the power generating element 12 is welded together at their respective outer edge portions.

The folded portion 113 is provided at a corner of the inner edge portion of the second outer casing portion 112. The folded portion 113 is a portion of the laminate film constituting the second outer casing portion 112, formed by folding back the laminate film. The folded portion 113 serves to reinforce the corner of the power generating element 12. FIG. 2 illustrates an example in which the folded portion 113 is provided at each of the four corners of the inner edge portion of the second outer casing portion 112. However, it is sufficient that the folded portion 113 be provided at least at one of the four corners of the inner edge portion of the second outer casing portion 112.

The power generating element 12 is a current collector for a bipolar electrode. This current collector is constituted by a first metal foil and a second metal foil bonded together via an electrically conductive adhesive layer, and an anode active material layer and a cathode active material layer respectively formed on the first metal foil and the second metal foil.

The first metal foil and the second metal foil are formed of, for example, copper foil, copper alloy foil, nickel foil, aluminum foil, aluminum alloy foil, stainless steel foil, or a carbon sheet. The first metal foil is, for example, a copper foil, and has the anode active material layer formed thereon. The second metal foil is, for example, an aluminum foil, and has the cathode active material layer formed thereon.

### Method for Manufacturing Energy Storage Module

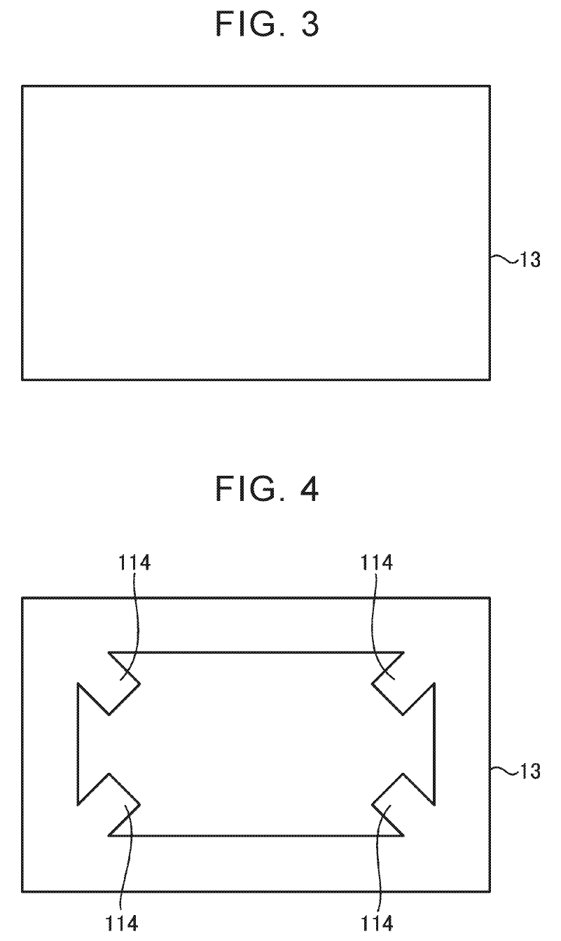

The method for manufacturing an energy storage module according to the embodiment will be described with reference to FIGS. 3 to 8. The method for manufacturing the energy storage module 1 includes a first step, a second step, a third step, a fourth step, and a fifth step.

### First Step

In the first step, as shown in FIG. 3, a laminate film 13 cut to a predetermined size is prepared. The laminate film 13 has a rectangular shape.

### Second Step

In the second step, as shown in FIG. 4, a central portion of the laminate film 13 is punched out such that the resulting opening has a predetermined shape. The laminate film 13 after the punching has four protrusions 114. Each protrusion 114 is located at a corresponding corner of the inner edge portion (i.e., a corresponding inner corner) of the frame-shaped laminate film 13.

### Third Step

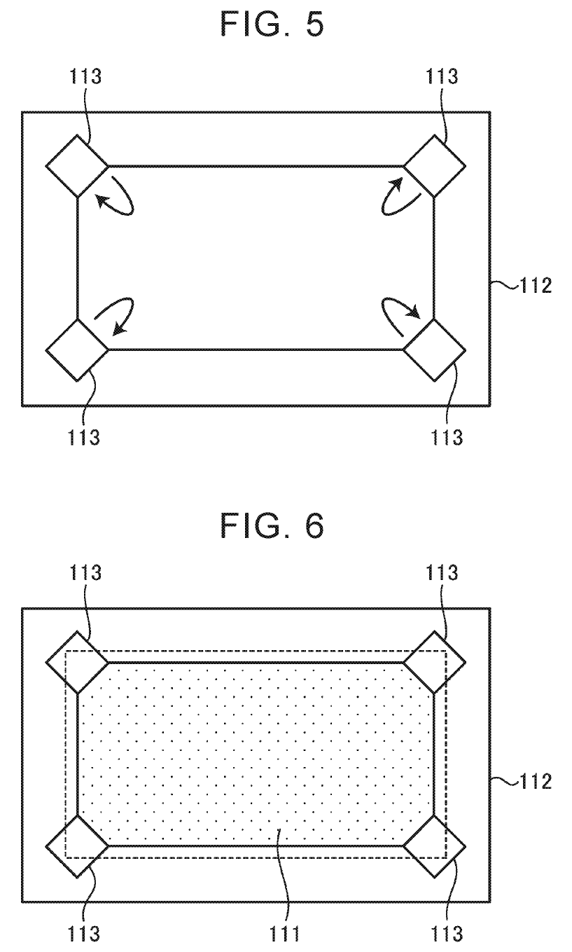

In the third step, as shown in FIG. 5, the four protrusions 114 are folded back and welded. The second outer casing portion 112 having the folded portions 113 is thus produced. The welding of the protrusions 114 may be performed using, for example, a heat bar or an impulse sealer.

### Fourth Step

In the fourth step, as shown in FIG. 6, the first outer casing portion 111 that serves to cover the surface of the power generating element 12 and the second outer casing portion 112 that serves to cover the corners of the power generating element 12 are welded together at positions where the corners of the power generating element 12 are to be located. At this time, the first outer casing portion 111 is disposed on the back side of the second outer casing portion 112 in the figure such that the outer edge portion of the first outer casing portion 111 overlaps the inner edge portion of the second outer casing portion 112. The welding of the first outer casing portion 111 and the second outer casing portion 112 may be performed using, for example, a heat bar or an impulse sealer.

### Fifth Step

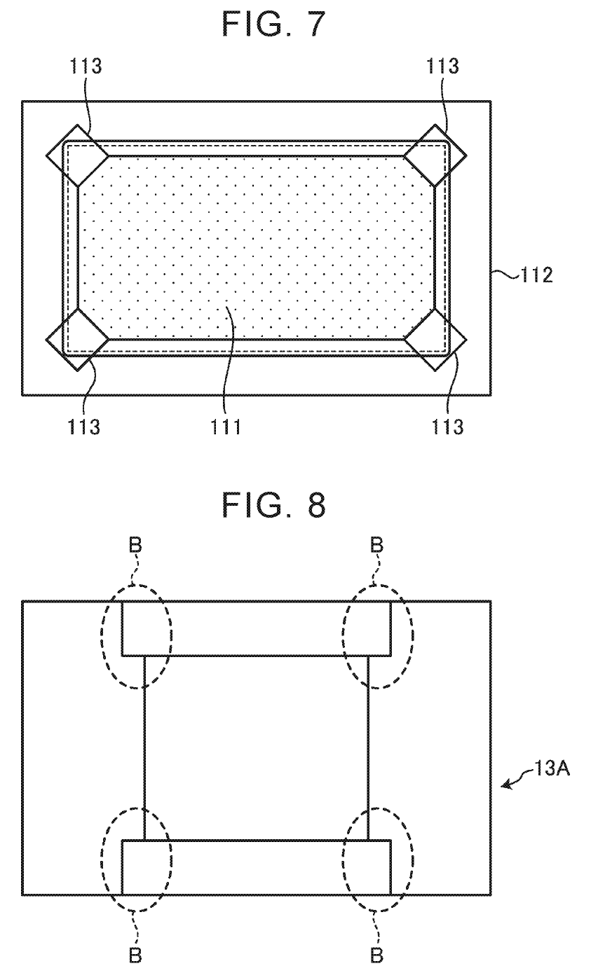

In the fifth step, a pair of the outer casings 11, each formed of the first outer casing portion 111 and the second outer casing portion 112, is respectively disposed above and below the power generating element 12. As shown in FIG. 7, embossing (convex molding) is then performed using a press mold. The energy storage module 1 is manufactured through the above steps.

In the first step described with reference to FIG. 3, the rectangular laminate film 13 is prepared. However, for example, as shown in FIG. 8, a laminate film 13A formed by combining a plurality of laminate film pieces may be prepared. The laminate film 13A is formed generally in a frame shape.

By using the laminate film 13A formed in advance in a frame shape in this manner, the amount of laminate film to be punched out in the second step can be reduced. As a result, the manufacturing yield of the energy storage module 1 is improved. When the laminate film 13A is used, the protrusions 114 are formed at, for example, the positions of parts B in FIG. 8 in the second step.

In the energy storage module 1 and the method for manufacturing the energy storage module 1 described above, the outer casing 11 is formed to have a multilayer structure at positions corresponding to the corners of the power generating element 12 and is welded. As a result, the strength of the outer casing 11 can be improved without managing gaps using spacers. Since spacers are not used in the energy storage module 1 and the method for manufacturing the energy storage module 1, the volumetric energy density does not decrease.

In order to improve the reliability of the outer casing of the energy storage module, it is desired to keep the gap between each corner of the embossed outer casing and a corresponding corner of the power generating element to a certain value or less. For example, if the gap is greater than the certain value under reduced pressure, wrinkling occurs, and repeated expansion and contraction may cause stress concentration, leading to rupture.

On the other hand, in the energy storage module 1 and the method for manufacturing the energy storage module 1, the laminate film constituting the outer casing 11 is folded into a multilayer structure and welded. As a result, the strength of the outer casing 11 can be improved. Furthermore, it is not necessary to manage the gap between each corner of the outer casing 11 and a corresponding corner of the power generating element 12. In addition, in the energy storage module 1 and the method for manufacturing the energy storage module 1, the laminate film is folded inward from the side of the first outer casing portion 111. As a result, the strength of the corners can be improved while suppressing a reduction in yield.

Further effects and modifications can be readily derived by those skilled in the art. Therefore, the broader aspects of the present disclosure are not limited to the specific details and exemplary embodiments shown and described above. Accordingly, various modifications may be made without departing from the spirit or scope of the general inventive concept defined by the appended claims and their equivalents.

What is claimed is:

1. An energy storage module comprising:
a power generating element; and
an outer casing that covers the power generating element, wherein:
the outer casing includes
a first outer casing portion that covers a surface of the power generating element, and
a second outer casing portion that covers a corner of the power generating element; and
the first outer casing portion and the second outer casing portion are welded together so as to overlap at a position where the corner of the power generating element is located.

2. A method for manufacturing an energy storage module, the method comprising welding a first outer casing portion configured to cover a surface of a power generating element and a second outer casing portion configured to cover a corner of the power generating element such that the first outer casing portion and the second outer casing portion overlap at a position where the corner of the power generating element is located.
